(19) United States
(12) Patent Application Publication
(10) Pub. No.: US 2020/0380436 A1
(43) Pub. Date: Dec. 3, 2020

(54) Employee Geo-Tracking Recorder & Processor Determining Potential Litigation Risk

(71) Applicant: Joseph M. Bonomo, Staten Island, NY (US)

(72) Inventor: Joseph M. Bonomo, Staten Island, NY (US)

(21) Appl. No.: 16/885,099

(22) Filed: May 27, 2020

Related U.S. Application Data
(60) Provisional application No. 62/853,152, filed on May 27, 2019.

(51) Int. Cl. G06Q 10/06; G06Q 10/10; G06Q 40/00; G06Q 30/00; G06Q 50/18; G06Q 50/26; H04W 4/021

(52) U.S. Cl. CPC G06Q 10/0635; G06Q 10/1091; G06Q 10/105; G06Q 40/125; G06Q 30/0206; G06Q 50/18; G06Q 50/26; H04W 4/021; G06Q 30/018

(57) ABSTRACT

A system and method for determining a level of risk of wage-and-hour litigation against a company, includes receiving, and storing in digital data storage, time-and-attendance data for employees of the company, received from mobile devices having geolocation capability and carried by employees of the company during work times, the data generated at least in part by detection by the mobile devices of breaches of a geofence associated with a workplace of the company. Confidence-weighted potential violations of wage-and-hour regulations by the employer are detected by a compliance engine which analyses the time-and-attendance data, payment records, and a digital library of wage-and-hour regulations. The confidence-weighting is based on employee absence data and a count of false-positive breaches of the geofence. The potential violations are analyzed with other risk data to determine the level of risk of wage-and-hour litigation against the company.

### CROSS-REFERENCE TO RELATED APPLICATIONS

This application claims the priority of U.S. Provisional Patent Application Ser. No. 62/853,152, filed May 27, 2019, the entirety of which is incorporated by reference for all purposes.

### FIELD OF THE SUBJECT TECHNOLOGY

The subject technology relates to systems and methods utilizing location-based services, and more particularly a system and method of geofence-based time tracking and recording for determining discrepancies with wage and hour laws and regulations which are used to determine a putative company's litigation exposure.

### SUMMARY OF THE SUBJECT TECHNOLOGY

According to an embodiment of the subject technology, a user registers on an application on an internet-connected mobile device their employer or job location(s), and the application confirms the current geographic location of the user's device against said pre-registered geofence(s). Each and every time the user's device breaches a registered geofence the application executes default actions, such as recording the amount of time within the geofence and the time the user enters and exits the virtual perimeter. The amount of total compensation received by the user during a pay period is recorded and compared with the aggregate amount of time recorded within a registered geofence for the same period. The quotient is then compared to the applicable federal, state and city wage and hour laws and regulations for discrepancies. Once the data is collected, a processor analyzes the data based upon certain pre-defined indicators, attribute how much weight to apply to each, and determine the company's potential litigation risk.

Importantly, the systems and methods of the subject technology enable the automated evaluation of the risk of wage-and-hour litigation with respect to a given firm or company by automatic data collection and analysis of multiple sources, including (1) digital collection of employee time-and-attendance data using geolocation features of mobile devices which is assigned an appropriate level of confidence, (2) a compliance engine that analyses the collected and confidence-weighted time-and-attendance data, a digital library of applicable regulations, and data from other sources, to identify potential violations of wage-and-hour laws and regulations and assign an appropriate level of confidence to said potential violations, and (3) a risk analysis engine which analyses the accumulation of confidence-weighted potential violations together with other data related to litigation risk, to result in a litigation risk evaluation.

As further described herein, the subject technology relates to a method for determining a level of risk of wage-and-hour litigation against a company, the method comprising the steps of: a. receiving, and storing in digital data storage, time-and-attendance data for employees of the company, during a time period, the time-and-attendance data received from a plurality of mobile devices having geolocation capability and carried by employees of the company during work times, the time-and-attendance data generated at least in part by detection by the mobile devices of breaches of a geofence, the breaches representing entry into and exit from the geofence, the geofence associated with a workplace of the company, the time-and-attendance data including employee presence duration, employee absence data, and a count of false-positive breaches of the geofence; b. receiving, and storing in digital data storage, payment records of compensation paid by the company to the employees for work performed during the time period; c. determining using a compliance engine, and storing in digital data storage, confidence-weighted potential violations of wage-and-hour regulations by the employer, the compliance engine identifying the potential violations by analysis of the time-and-attendance data, the payment records, and a digital library of wage-and-hour regulations, the analysis including identifying applicable wage-and-hour regulations according to a type of employee, a type of employer, and a jurisdiction, and confidence-weighting the potential violations based on at least one of the employee absence data and the count of false-positive breaches of the geofence; d. determining, and storing in digital data storage, potential violation risk factors, based on the confidence-weighted potential violations, the potential violation risk factors including at least one of the following: recidivist risk level, monetary level, cycle time, duration, corroboration, false positive; e. receiving, and storing in digital data storage, additional risk factors associated with the employer, the additional risk factors including at least one of the following: a judgment proof value, class action viability, collective action viability, venue, projected legal costs, dismissal rate; f. determining, using a digital risk analysis engine, the level of risk of wage-and-hour litigation against the company based on the confidence-weighted potential violations and the additional risk factors.

Furthermore, as further described herein, the subject technology relates to a system for determining a level of risk of wage-and-hour litigation against a company, the system comprising: a computer system comprising digital data storage and one or more processors, programmed and configured to receive, and store in the digital data storage, time-and-attendance data for employees of the company, during a time period, the time-and-attendance data received from a plurality of mobile devices having geolocation capability and carried by employees of the company during work times, the time-and-attendance data generated at least in part by detection by the mobile devices of breaches of a geofence, the breaches representing entry into and exit from the geofence, the geofence associated with a workplace of the company, the time-and-attendance data including employee presence duration, employee absence data, and a count of false-positive breaches of the geofence; the computer system programmed and configured to receive, and store in the digital data storage, payment records of compensation paid by the company to the employees for work performed during the time period; the computer system comprising a compliance engine, configured to determine, and store in the digital data storage, confidence-weighted potential violations of wage-and-hour regulations by the employer, the compliance engine identifying the potential violations by analysis of the time-and-attendance data, the payment records, and a digital library of wage-and-hour regulations, the analysis including identifying applicable wage-and-hour regulations according to a type of employee, a type of employer, and a jurisdiction, and confidence-weighting the potential violations based on at least one of the employee absence data and the count of false-positive breaches of the geofence; the computer system configured to determine, and storing in digital data storage, potential violation risk factors, based on the confidence-weighted potential violations, the potential violation risk factors including at least one of the following: recidivist risk level, monetary level, cycle time, duration, corroboration, false positive; the computer system configured to receive, and store in the digital data storage, additional risk factors associated with the employer, the additional risk factors including at least one of the following: a judgment proof value, class action viability, collective action viability, venue, projected legal costs, dismissal rate; the computer system comprising a digital risk analysis engine configured to determine the level of risk of wage-and-hour litigation against the company based on the confidence-weighted potential violations and the additional risk factors.

### BRIEF DESCRIPTION OF THE DRAWINGS

FIG. 1 is a block diagram showing, according to a non-limiting embodiment, a mobile device, computer system, and communication link between them.

FIG. 2-5 are schematic diagrams showing the geographic motion of a mobile device with respect to a jobsite defined as a cluster of geofence locations, according to a non-limiting embodiment.

FIGS. 6-14 are data structure diagrams showing file formats for data storage, according to a non-limiting embodiment.

### DETAILED DESCRIPTION OF THE SUBJECT TECHNOLOGY

According to an aspect of the subject technology, a worker or hired individual (“User”) uses a mobile device to access an application store and download onto their device a location-based application (“Application”). The Application may be made available from a law firm or employer, it may be associated with a service provider used by the employer such as a payroll processor, or it may be an independent service provider that evaluates litigation risk in the context of, among others, mergers and acquisitions.

The Application has both active and passive qualities, which allow it to run in the background of the user's mobile device and active qualities and enable the application to interact with the User.

Once downloaded onto the device, the User will initially spend several minutes registering, filling out an intake form and questionnaire regarding basic employment information (“Registration”). The User's responses, such as whether the employment is transient or stationary, will determine which commands the application and processor will run, how often it will run the commands, how to sort wage and hour information obtained, and how value each litigation risk indicator. The Registration phase can occur in any number of ways, including entering the data into the application, on a computer or other internet-connected devices.

Employment information obtained during the Registration phase will include, but not be limited to User's work and pay schedule, pay structure and method, employment type, general duties and activities, the employer's name, address, and other pertinent information concerning the workplace and/or job location(s) of the respective User. Additional employment information can be added, deleted or modified any time during or subsequent to the Registration phase.

The location related information will be used to register geofence(s). A geofence can consist of any one or more of the following: the employer's office, property, jobsite, the User's workstation or any location where a User performs employment-related activities (“Workplace”). The Workplace may automatically be determined from information manually entered by the user or publicly available via third-party application. The virtual perimeter may encompass the entire place of employment, such as a restaurant, a storefront, etc., or define a section inside a building, or encompass the grounds surrounding a building as well as the building.

Once the Application defines a geofence boundary around the Workplace it will store the geofence boundary data locally in the data storage unit of the user device, such as, for example, the cache of a user's mobile phone.

One or more sectors of geofences or “clusters” within a location may be established in a single or combination geofence. The clusters may be established using a wireless network or a network and may define one or more zones within the location. For example, it may define different zones of a restaurant (e.g. kitchen, dining room, bathrooms, cashiers, bar, etc.), different zones of a grocery store (e.g. produce, meat, baked goods, frozen section, etc.), and/or the like.

If the employment is transient, the user can save multiple geofences and as job locations. Thus, geofences may be generated and defined based on such factors as a job situs, job type (e.g. a city-wide virtual perimeter for a delivery driver, a room-sized virtual perimeter for an office worker, multiple locations for users traveling to customer locations, etc.).

For travelling employment, such as long-distance truck drivers, geofences can be registered to origin and destination points and on either side of a predefined route to allow the application to track the user's mobile device while he/she travels between each point. The speed of the mobile device may be used to verify whether the driver is performing employment duties. The Application may also connect with a Bluetooth device located within the vehicle or with other navigation-based applications such as Waze or Google Maps while the User is traveling between the points.

The Application determines and geo-tracks in real time the longitude and latitude coordinates of the user device in conjunction with a location-based service. The location may be obtained through any one or a combination of: global positioning satellite (GPS) system, location-based service (LBS), network connection, Bluetooth connection or wireless internet connection. The longitude and latitude coordinates may be determined within a tolerance of about twenty feet.

The Application passively monitors the geographic location of the User's mobile device and determines when the user device enters or exits the geofence. Based the geofence breach, the Application executes instructions that are stored in the mobile device to cause the Application to run several commands and perform processes described herein.

The commands and/or processes confirm the location of the User's mobile device, determine that the User's mobile device is within a geofence, geo-track and record the User's time and leave information, activity, speed and altitude and provide combined alert notifications.

Specifically, the Application's commands and/or processes include, but are not limited to: Monitoring the mobile device once it enters the geofence; Recording the timing of the entry breach into the perimeter (i.e., documenting the entry as a clock-in); Recording the geographical coordinates (the longitude, latitude, speed and altitude of the device) of the virtual perimeter breach; Generating and sending a request to the mobile device to confirm the User has begun work; Recording the duration within the breached area; Recording the duration outside the breached area (e.g., meal and relief periods); Comparing the recorded geofence entry and exit times of the User's mobile device to calculate a total amount of time therein; Recording the travel time between multiple geofence “clusters” (for transient types of employment such as construction workers traveling between sites); Providing a combined alert on the user device regarding the type of breach event; Determining that user's mobile device is outside of the geofence after a specified period of time (i.e., documenting the entry as a clock-out); Tracking the location, movement and activity via an activity monitor while within the perimeter; and Analyzing the data collected to generate a variety of reports based, at least, in part, on the data gathered from monitoring the user's mobile device within the geofence.

The reports for each user may be generated hourly, daily, weekly, monthly and they may coincide with the pay period, or the like. The report may also: Provide information such as deviations or other such breaks from normal employment duties; Compare mobile device data to a schedule and determine the timeliness of a user; Compare time-stamps from the mobile device relating to when the User entered and exited the location with the time entry log and automatically validate the time entry log; and Highlighting any discrepancies between the time-stamps and the time entry log.

Since the User's proposed schedule for a defined period of time will automatically be obtained from information entered in connection with the Registration phase (or subsequent thereto), breaches exiting the perimeter during the hours of the proposed schedule can be treated as meal and relief periods, errand runs, refilling the parking meter, etc. This time outside the Workplace can also be counted as the same time within the Workplace.

The exit time may be compared to a work schedule of the User's hours-based information manually entered in connection with the Registration phase (or subsequent thereto). The method may compare the exit time to the User's scheduled hours and determine the User should be clocked-out and may automatically record the breach as the clock-out time. The Application may prompt the User's mobile device to confirm whether the User forgot to clock out or alerting them that unless they return to the location within a specified time period, the breach will be recorded as a clock-out for the day.

While the User is located within the geofenced area, various attributes of the device can be tracked with the Application (e.g. speed, altitude, periods of non-movement, etc.).

The User's movement will be tracked to determine if the device is currently in motion or is stagnant in a location. It is noted that exiting the geofence, i.e., a clock out, during middle of the day can be marked as a ‘lunch’ or other predefined event (e.g. offsite meeting, break, errand to purchase goods and/or services, etc.). This excused time outside the Workplace can be counted the same as time within the Workplace. Excessive movement, however, may consist of too many smoke breaks, bathroom breaks, or other such departures from the User's employment duties and the Application may prompt the User to solicit more information.

The recording and tracking instructions/commands will be done automatically based upon GPS/LBS or other source (e.g. the location of the User's mobile device). For additional accuracy, LBS verification will be utilized by running a command to send an alert to the user asking for confirmation of entry, exit, etc., concerning the Workplace.

If the mobile device has not yet entered the geofence due to proximity or if, for example, when a User first arrives at a location the user may need to stow their lunch, put away their personal belongings and/or the like prior to starting work, the mobile device may be prompted via the Application to clock-in to work upon arrival. The user may elect to dismiss the prompt and/or be reminded again (snooze) within a short time frame such as five (5) minutes. This may allow the User time to properly stow personal items and prepare for work.

The information obtained, such as time stamps for perimeter breaches, will be generated into a report akin to a time sheet for a user of a company, which may be compared to time-stamps on a time entry log from a time entry database maintained, controlled, or within the custody of the employer.

The data obtained may be in the form of raw data such as, for example, times at which a user's mobile device registers a “clock-in” or “clocks-out”, days of the week that a user logs at least some hours of work, user safety data, or user movement and productivity while within a geofence, and other data associated with the employment. The data may also include at least partially analyzed and/or processed data such as a comparison of a user's hours to other similarly situated user's, whether a user's hours meet certain criteria, whether a user arrived on time, whether a user's clock-in time corresponds to an employer device clock-in time, whether a user took too many breaks, or was stagnant for an extended period of time, logged into work late, etc.

The aggregated amount of time that the user's mobile device is in the geofence is recorded on the equivalent of a time sheet for a specified period of time such as a payroll period, which can be weekly, bi-monthly or some other temporal measurement.

The User's mobile device may also include storage capability accessible by the Application. For example, the data storage unit may store, at the option of the user, data regarding the location of the device, such as digital fence intrusions that are or have been breached by the user device. The data storage unit of the user device can also store content related to the location data, work data, mobile device movement, notifications, schedules, contact information, and the like associated with their employment.

The User's pay record and pay period information is obtained through any one or a combination of: Pre-authorization for production of a paystub from a payroll processor such as paychex, ADP, etc.; the User can manually input the information; the User can use a mobile device with a built-in camera (e.g., iPhone, BlackBerry, etc.) to take a picture of the paycheck and upload it to the Application which may then perform an Optical Character Recognition (OCR) procedure on the image of the User's paycheck to determine whether the characters on the check image is legible. The characters and data are extracted, stored locally on the device and listed in a grid. All information on the pay stub such as commissions, sales, bonuses, etc. are added to the grid and sorted.

A computer processor (“Processor”) on the Application runs several commands to calculate the User's average hourly wage rate. Specifically, the User's total remuneration in a given pay period is divided by the total amount of recorded time (based upon the perimeter breaches) from a given pay period.

The Processor determines discrepancies based upon federal and state wage and hour laws (“Verification”). This verification process, which may be performed by a compliance engine comprised of one or more software routines for comparing payroll information and the breach data to applicable regulations, may occur in real-time and may prompt the user to verify certain information. For example, if the Application determines that a user have spent more time outside the geofence than within it as compared to the User's work schedule, the application can flag this entry as possibly containing an error.

Data is collected from a variety of points such as: User database, geofence breaches, travel time to/from home and during meal periods, paystub or user submitted information, wage and hour laws and regulations, publicly available information of employers, User E-ZPass records and cell phone statements, third-party applications on a user's mobile phone, etc.

Once the data is aggregated a processor analyzes it based upon several key risk indicators (“Indicators”) including, but not limited to: Recidivist Risk Level (Individual): Frequency of total violations per User based on defined period; Recidivist Risk Level (Workforce): Number of Users with violations from the same employer; Monetary Level (Individual): Dollar amount owed per total violations per user; Monetary Level (Workforce): Dollar amount owed per total violations per all Users of same employer, which then creates a function to calculate potential amounts owed for liquidated damages, costs, and fees; Cycle Time (Individual and Workforce): the number of days/hours between violations of each User to determine, among others, information staleness; Duration (Individual and Workforce): Comparison of earliest and latest determined violations per user; Judgment Proof: Publicly available information on the company including asset and liability searches, outstanding judgments and liens, prior bankruptcy filings, history of prior lawsuits; Class/Collective Action Viability: Comparison of the number of employees in the job classification from the user registration phase or publicly available information; Projected Legal Costs: expenses preparing legal documents based upon factors such as access to employer timekeeping and payroll records, company size, class/collective size, complexity of legal issues, etc.; Corroboration: Comparison of geofence breaches to other devices including Apple IWatch, Airpods and similar devices, Fitbit, activity monitors and across multiple Users of same employer; Dismissal Rate: Level of de minimus violations and authenticity and credibility of corroborating evidence; Venue: Compared with average figures from similar cases or averages for segments of prior cases in relation to gross settlement amounts, attorney hourly rates, and approved distribution awards; Work Product: Measurement of the amount of time needed to prepare for and complete a Pre-Litigation Phase, Pleadings Phase, Motions Phase, Discovery Phase, and a Trial Phase to reach resolution; and False Positive: Measurement of potentially incorrect geofence recordings for real-time correction such as more time spent outside than inside the geofence on a given shift.

The Processor compares the results from the Indicators and based upon an algorithm it allocates more or less weight to certain of them based upon relative value. For example, the greater the value of the Recidivist Risk Level, the more weight it is allocated. The Processor then collectively evaluates all of the Risk Assessment Indicator values and scores a company's litigation risk on a sliding scale ranging from minimal litigation exposure to high litigation risk (“Score”).

All the data along with the detected discrepancies, aggregated data, Risk Assessment Indicator Values and Score will be sorted into a software program. This information can then be reviewed by a professionally licensed attorney for potential wage and hour violations and used for enforcement purposes, due diligence of mergers and acquisitions, compliance, or other compliance purposes.

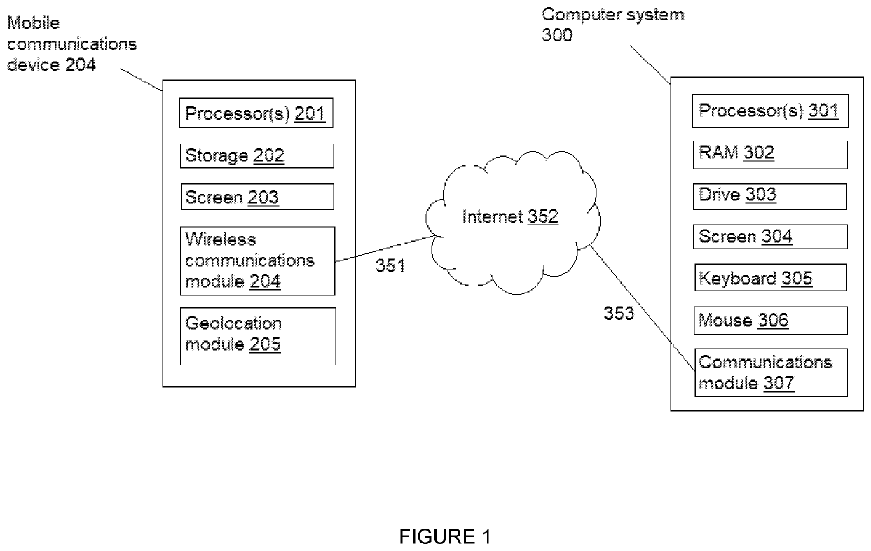

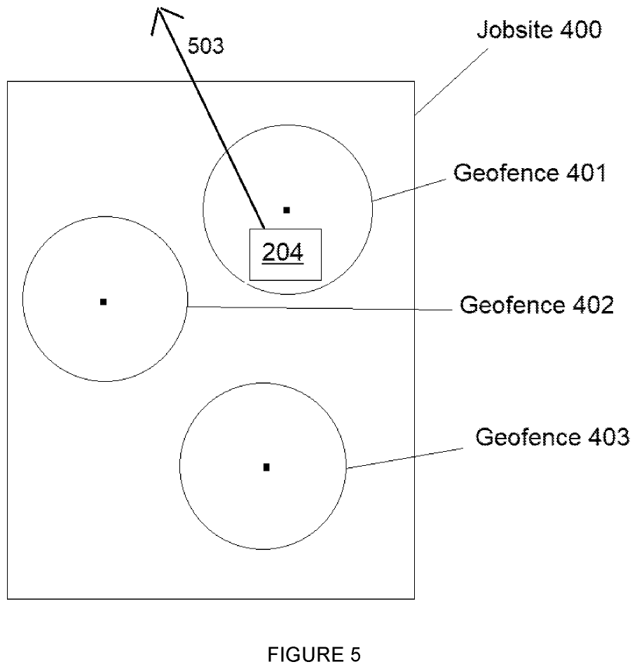

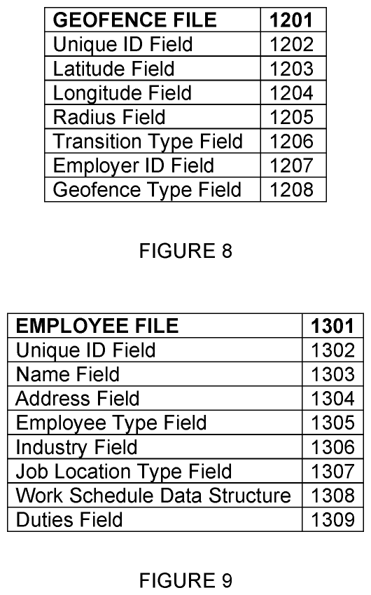

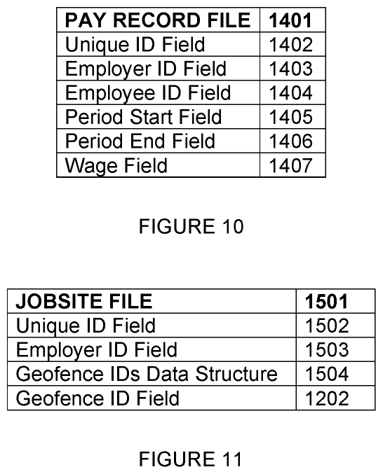

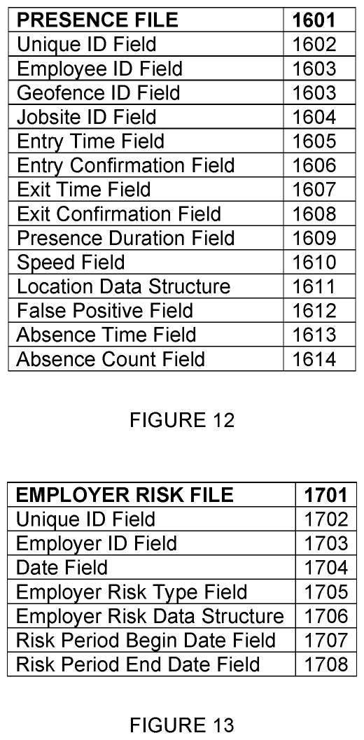

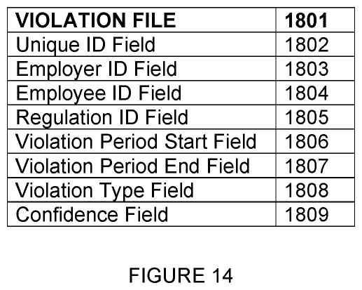

As shown for example in FIGS. 1-14, an exemplary embodiment of the subject technology is as follows. It will be understood by those of skill in the art that the exemplary embodiment may be varied, adapted and/or extended with additional features, structures and functions as previously described herein.

As shown for example in FIG. 1, mobile communication device 200 is a programmable computing device comprising one or more processors 201, operably associated with digital memory storage 202 for storing data on the device 200, a user interface screen 203 for presenting information and receiving information from a user, a wireless communications module 204 (for example a cellular radio) for connecting wirelessly to one or more cellular communication towers and/or the Internet, and a geolocation module 205 (for example, a GPS module) for determining the current location of device 200. Mobile communication device 200 may be, for example, a smart device, smartphone, smart table, or other mobile device having similar functionality, known to the art.

According to a further aspect of an embodiment of the subject technology, as shown in FIG. 1, a computer system 300 is provided. Computer system 300 is programmable for data acquisition, storage, processing and output, according to the present disclosure. Computer system 300 preferably comprises one or more one or more processors 301, operably associated with digital memory storage for short-term (e.g. RAM 302) or long-term (e.g. fixed disk drive or solid state drive 303) storage of data on the device 200, a user interface screen 304 for presenting information and receiving information from a user, a keyboard 305 and mouse 306 for receiving information from a user, a digital communications module 307 (for example a cellular radio or network card) for communicating with other digital devices, ultimately via the internet, and may further be operably associated with other computing peripheral devices such as printer(s), scanner(s), etc. as known in the art.

Device 200 and computer system 300 are in data communication contact, at least part of the time, and can mutually send, receive and communicate digital data through a data link, which may be comprised of one or more data connection segments, for example, a cellular data communication segment 351 between device 200 and the internet 352, and a wired or wireless data communication segment 353 from the internet 352 to computer system 300. Device 200 and computer system 300 are programmed and configured to interoperate and implement the features and functions described in more detail herein. Both device 200 and computer system 300 have digital memory storage, as described above, and the data described in the embodiments may be stored on the device 200, on system 300, or on both, as appropriate.

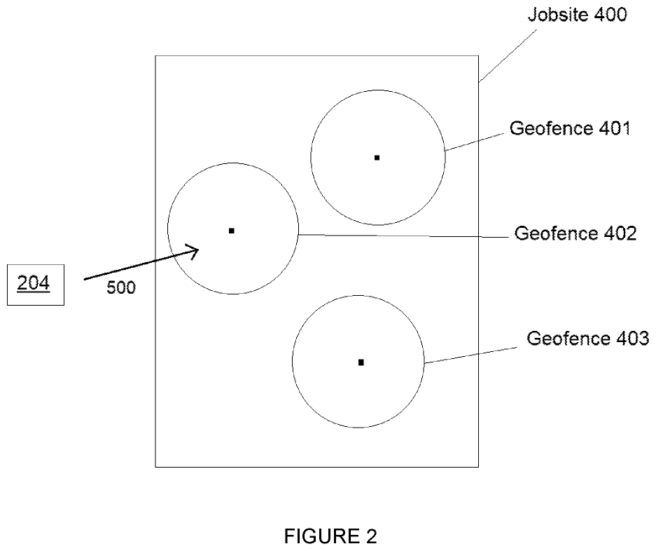

FIGS. 2-5 are schematic diagrams showing a sequence of spatial configurations of device 200 with respect to jobsite 400 and associated geofences 401, 402, 403 according to an aspect of the subject technology. It should be understood that device 200 is in data communication, at least part of the time, with computer system 300 via internet 325, although this is not explicitly shown in these figures.

In FIGS. 2-5, jobsite 400 schematically represents a place of employment, for example, a factory. Geofences 401, 402, 403 are virtual geographic boundaries within jobsite 400 each defined as a radius about a central point (in an embodiment). Geofences 401, 402, 403 are defined and associated with jobsite 400 within computer system 300, as hereinafter described. Device 200 is configured and programmed to detect entry into any of said geofences 401, 402, 403 (i.e., the device 200 physically crossing from outside the boundary to inside the boundary), and similarly, to detect exit from any of said geofences, as known in the art.

In an exemplary embodiment, jobsite 400 is a factory, and geofences 401, 402, 403 are geographical regions associated with jobsite 400 and defining regions of that factory that are pertinent to workplace time and attendance. In an embodiment, 401 defines an assembly line station where workers assemble products, 402 defines a locker room where employees arrive to prepare for the day, 403 defines a break room where work does not take place.

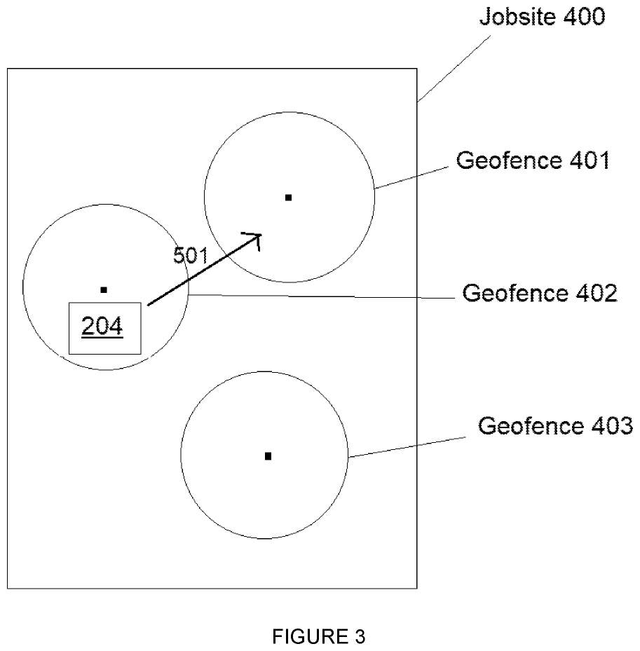

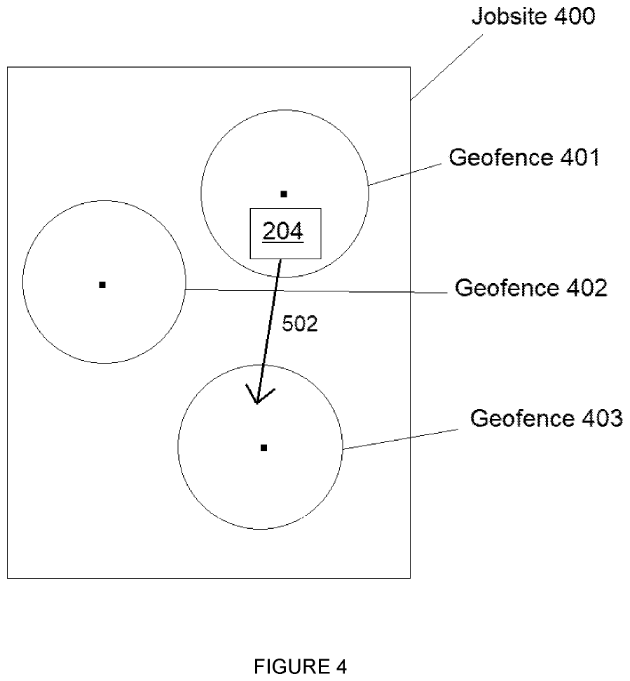

Device 200 is configured and programmed to detect entry into any of these regions by detecting breaches (entry or exit) of the associated geofence. Breaches of geofences 401, 402, 403 by device 200 triggers process events according to the subject technology, which are more fully disclosed in the below description of “Process 1: Daily Time and Attendance of a User.” To provide here a brief explanation, as shown for example in FIG. 2, at the start of a workday, device 200 carried by a user/employee crosses into jobsite 400 (indicated by arrow 500) and breaches geofence 402, which denotes a locker room. The subject technology has stored data concerning geofence 402, and as described below, recognizes that the employee's payable workday has not yet begun. As shown in FIG. 3, at a later time, device 200 carried by the user/employee exits geofence 402 and enters geofence 401 (indicated by arrow 501), which the subject technology recognizes as work area. Therefore, the entry into geofence 402 is presumptively the start of a workday, subject to verification, as further described below. As shown in FIG. 3, at a later time, device 200 carried by the user/employee exits geofence 401 and enters geofence 403 (indicated by arrow 503), which the subject technology recognizes as break area. Therefore, the entry into geofence 403 is presumptively the start of a period of absence, subject to verification, as further described below (the period of absence ending upon exit of geofence 403 and entry into geofence 402 at a later time). As shown in FIG. 4, at a later time, device 200 carried by the user/employee exits geofence 401 and jobsite 400, which is recorded by the subject technology as the end of a workday, subject to verification, as further described below.

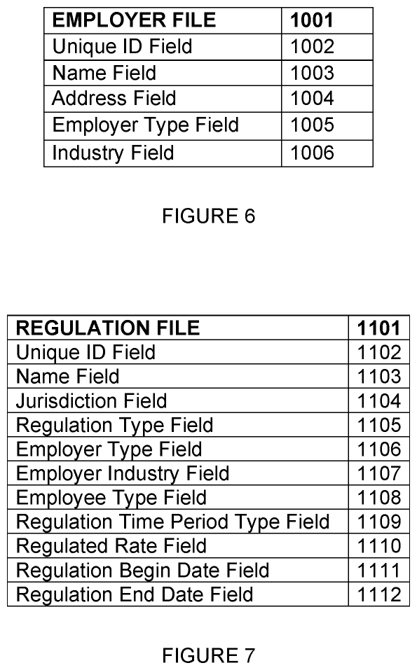

Data is recorded and stored in the data storage of device 200 and/or computer system 300, including for example the following files and file/record formats, as shown for example in FIGS. 6-14.

Employer file 1001 comprises a unique ID field 1002, a name field 1003 for storing a name of the employer, an address field 1004 for storing an address of the employer, an employer type field 1005 for storing a type of the employer for wage-and-hour purposes, an industry field 1006 for storing the employer's industry, and may include other fields to store other aspects of the employer. Field 1005 may be further explained as follows. Certain state and federal wage and hour laws have variable application depending on the type of employer, for example, in New York, the minimum wage varies depending on whether, for example, the employer is a New York City employer, a small employer, or a large employer. Field 1005 stores the applicable identifier to match the employer with the applicable regulations, for example, “NYC-Large,” “NYC-Small,” “Long Island and Westchester,” etc. Field 1006 may be further explained as follows. Certain state and federal wage and hour laws have variable application depending on employer's industry, for example, in New York, hospitality, building industry, non-profit, farm, etc. employers may be subject to different regulations. Field 1006 stores the applicable industry to match the employer with the applicable regulations.

Regulation file 1101 comprises a unique ID field 1102, a name field 1103 for storing a name of the regulation, a jurisdiction field 1104 for storing the jurisdiction of the regulation (for example, “Federal,” “New York,” “New Jersey,” etc.), a regulation type field 1105 for storing the type of regulation (for example, “Minimum Wage,” “Overtime,” “Spread of Hours,” etc., an employer type field 1106 for storing the type of employer affected (for example, “NYC-Large,” “NYC-Small,” “Long Island and Westchester,” etc.), an employer industry field 1107 for storing the employer's applicable industry (for example, “hospitality,” “building,” “farm,” “other services,” etc.), an employee type field 1108 for storing the applicable employee type (for example, “non-tipped,” “tipped,” “piece work,” etc.), a regulation time period type field 1109 for storing the type of time period the regulation applies to (for example, “hour,” “day,” “week”), a regulated rate field 1110 for storing the applicable regulated rate, a regulation begin date field 1111 for storing the first date the regulation is in effect, a regulation end date field 1112 for storing the last date the regulation is in effect, and may include other fields to store other aspects of the regulation.

Geofence file 1201 comprises a unique ID field 1202, a latitude field 1203 for storing the latitude of the center of the geofence, a longitude field 1204 for storing the longitude of the center of the geofence, a radius field 1205 for storing the radius of the geofence from the center, a transition type field 1206 for storing the transition type of the field (for example, “Enter” or “Exit”), an employer ID field 1207 keyed to the unique employer ID field 1002 to match the geofence to a specific employer, a geofence type field 1208 to store the relevant type of geographical region defined by the geofence (for example, work area, break room, locker room, employer's office, employer's property, kitchen, dining room, bathroom, cashier station, bar, store section, travel origin point, travel destination point, etc.) and may include other fields to store other aspects of the geofence.

Employee file 1301 comprises a unique ID field 1302, a name field 1303 for storing a name of the employee, an address field 1304 for storing an address of the employee, an employee type field 1305 for storing a type of the employee for wage-and-hour purposes (for example, “non-tipped,” “tipped,” “piece work,” etc.), an industry field 1306 for storing the employee's industry (for example, “hospitality,” “building,” “farm,” “other services,” etc.), a job location type field 1307 for storing the type of job location (for example, “stationary” or “transient”), a work schedule data structure 1308 for storing a work schedule of the employee, a duties field 1309 for storing a description of the employee's duties, and may include other fields to store other aspects of the employee.

Pay record file 1401 comprises a unique ID field 1402, an employer ID field 1403 keyed to the unique employer ID field 1002 to match the pay record to a specific employer, an employee ID field 1404 keyed to the unique employee ID field 1302 to match the pay record to a specific employee, a period start field 1405 to store the start of the pay period, a period end field 1406 to store the end of the pay period, and a wage field 1407 to store the wage compensation paid, and may include other fields to store other aspects of the pay record.

Jobsite file 1501 comprises a unique ID field 1502, an employer ID field 1503 keyed to the unique employer ID field 1002 to match the jobsite to a specific employer, and a geofence IDs data structure 1504 for storing one or more geofence IDs keyed to unique geofence ID field 1202 for storing a cluster of one or more geofence locations associated with the jobsite, and may include other fields to store other aspects of the jobsite.

Presence file 1601 comprises a unique ID field 1602, an employee ID field 1603 keyed to the unique employee ID field 1302, a geofence ID field 1603 keyed to the unique geofence ID field 1202 and a jobsite ID field 1604 keyed to unique jobsite ID field 1502, to associate the presence data with a unique geofence and jobsite, an entry time field 1605 for storing the time the employee begins a presence period at the geofence and jobsite, an entry confirmation field 1606 for storing a flag to indicate whether the employee has confirmed that the entry is the commencement of a work period, an exit time field 1607 for storing the time the employee ends a presence period at the geofence and jobsite, an exit confirmation field 1608 for storing a flag to indicate whether the employee has confirmed that the exit is the end of a work period, a presence duration field 1609 for storing the presence duration, a speed field 1610 for storing the employee's speed during the presence duration as determined by the mobile device, a location data structure 1611 for storing the latitude, longitude, and altitude of the presence, a false positive field 1612 for storing a number to indicate the number of false positive entry/exit transactions for this presence, an absence time field 1613 for storing a number to indicate the amount of time during the presence period that the employee was detected to be in a non-work geofence area (e.g. a bathroom, break room, lunch room), an absence count field 1614 for storing a number to indicate the number of occasions during the presence period that the employee was detected to be in a non-work geofence area, and may include other fields to store other aspects of the presence.

Employer risk file 1701 comprises a unique ID field 1702, an employer ID field 1703 keyed to the unique employer ID field 1002 to match the employer risk entry to a specific employer, a date field 1704 for storing the date the employer risk entry was added to the file 1701, an employer risk type field 1705 for storing the type of employer risk (for example, recidivist risk level (individual) (i.e., frequency of total violations per user based on defined period), recidivist risk level (workforce, i.e., number of users with violations from the same employer), monetary level (individual) (i.e. dollar amount owed per total violations per user), monetary level (workforce) (i.e., dollar amount owed per total violations per all users of same employer, cycle time (individual and workforce) (i.e, the number of days/hours between violations of each user to determine, among others, information staleness), duration (individual and workforce) (i.e., comparison of earliest and latest determined violations per user), judgment proof (i.e., publicly available information on the company including asset and liability searches, outstanding judgments and liens, prior bankruptcy filings, history of prior lawsuits), class/collective action viability (i.e., comparison of the number of employees in the job classification from the user registration phase or publicly available information), projected legal costs (i.e., expenses preparing legal documents based upon factors such as access to employer timekeeping and payroll records, company size, class/collective size, complexity of legal issues, etc.), corroboration (i.e., comparison of geofence breaches to other devices, activity monitors and across multiple users of same employer), dismissal rate (i.e., level of de minimus violations and authenticity and credibility of corroborating evidence), venue (i.e., compared with average figures from similar cases or averages for segments of prior cases in relation to gross settlement amounts, attorney hourly rates, and approved distribution awards), work product (i.e., measurement of the amount of time needed to prepare for and complete a pre-litigation phase, pleadings phase, motions phase, discovery phase, and a trial phase to reach resolution), and false positive (i.e., measurement of potentially incorrect geofence recordings for real-time correction such as more time spent outside than inside the geofence on a given shift)), an employer risk data structure 1706 for storing the information pertinent to the employer risk record, a risk period begin date field 1707 and a risk period end date field 1708 for storing the applicable begin/end date for the risk being stored in the record (e.g., over what date period did the violations occur) and may include other fields to store other aspects of the employer risk.

To further explain employer risk data structure 1706 for storing the information pertinent to the employer risk record, data structure 1706 will have a structure suited to the type of employer risk being stored in a given record of file 1701. For example, “recidivist risk level (individual)” (i.e., frequency of total violations per user based on defined period) may require a data structure which stores the following values: defined time period, count of violations per employee during the defined time period. As another example, the employer risk type “monetary level (individual)” (i.e. dollar amount owed per total violations per user) may require a data structure which stores the following values: total dollar amount of violations (i.e., deficiency in wage actually paid vs. the wage required by law) divided by number of employees, maximum dollar amount of violations, average dollar amount of violation. As another example, employer risk type “recidivist risk level (workforce)” (i.e., frequency of total violations per user based on defined period) may require a data structure which stores the following values: defined time period, number of employees during the defined time period, count of violations per employee during the defined time period. As another example, employer risk type “recidivist risk level (workforce)” (i.e., number of users with violations from the same employer) may require a data structure which stores the following values: number of employees, count of employees having at least one violation. A person of skill in the art will be able to determine appropriate data structures for employer risk data structure 1706 given these examples.

Violation file 1801 comprises a unique ID field 1802, an employer ID field 1803 keyed to the unique employer ID field 1002 to match the violation record to a specific employer, an employee ID field 1804 keyed to the unique employee ID field 1302 to match the violation record to a specific employee, a regulation ID field 1805 keyed to the unique regulation ID 1102 to match the violation record to a specific regulation, a violation period start field 1806 to store the start of the violation period, a violation period end field 1807 to store the end of the violation period, a violation type field 1808 to store the type of violation (for example, paid hourly wage under minimum hourly wage, spread of hours violation, etc.), a confidence field 1809 to store a value representing a level of confidence in the violation record, and may include other fields to store other aspects of the violation risk.

According to the subject technology, certain of the foregoing files may be populated with data by manual entry. In an embodiment, employee file 1301 is populated with data entered during the user registration procedure as previously described. In an embodiment, employer file 1001, regulation file 1101, geofence file 1201, and jobsite file 1501 may be populated and set up by manual entry of data during set up of the system. In an embodiment, pay record file 1401 may be populated and set up by manual entry, imaging and optical character recognition by device 200 of user's pay stubs, importation from user's payroll processor via an API, or other means of acquiring payroll data. Other files in the system of the subject technology are wholly or partially populated by automatic data acquisition, processing, verification, and entry, as described hereafter.

The system of the subject technology is configured, adapted and programmed to carry out processes of acquiring, storing, verifying, and analyzing data, including the following. Process 1: Daily Time and Attendance of a User; Process 2: Verification and Correction of Daily Time and Attendance Data; Process 3: Identification of Potential Violations of Regulations; Process 4: Population of Employer Risk File from Violation Data; Process 5: Population of Employer Risk File from Public Data; Process 6: Analysis of Employer Risk Data. Embodiments of the foregoing processes according to the subject technology may be carried out as follows.

Process 1: Daily Time and Attendance of a User.

It should be understood that the user has on his or her person, during the user's workday, mobile device 200 with geolocation capability, programmed and configured as described herein. Process 1 includes the steps of: 1. Detecting breach of a geofence 401, 402, 403 defined in geofence file 1201 by mobile device 200; 2. Associating the breached geofence with a jobsite and employer as defined in jobsite file 1501; 3. Determining whether the breach is an entry or exit of the geofence; 4. Verifying whether the entry/exit is a valid start/end of a work presence period by the user, 5. Conditional on the entry/exit occurring a work presence period (i.e. after a valid start and before a valid end of the work presence period), determining whether the entry/exit indicates absence from a work area and if so, incrementing absence count field 1613 when detecting exit from a work area, and accumulating the time spent in absence from the work area in absence time field 1613 when detecting entry into a work area, 6. Determining whether the geofence breach should be counted as a false positive, 7. Writing or updating a presence record in presence file 1601. Step 4 (verification) may include one or more of the following steps: 4.a, Determining from geofence type field 1208 whether the geofence represents a work area (so that entry may be start of a presence period, exit may be the end of a presence period) or a non-work area (so that entry may be the end of a presence period, exit may be start of a presence period), 4.b Determining from the work schedule data structure 1308 (if present) to determine if the breach time is an appropriate time for the work presence period to start/end, 4.c Displaying a notification on device 200 for data entry by the user (for example, “Start work presence?” or “End work presence?”), 4.d Determining whether an exit breach of a work area does not indicate the end of the employee's work presence time, for example, exiting a work area geofence, then entering a bathroom geofence, and shortly thereafter, exiting the bathroom geofence, then entering a work area geofence, which indicates a permitted bathroom break. Step 6, which is triggered by a failure to verify a start/end of a work period in step 4.b, may include one or more of the following steps: populating the presence record of presence file 1601 by incrementing false positive counter 1612 and updating the presence record. Step 7 may include one or more of the following steps: 7.a, for a verified start of a work period, populating and writing a presence record in presence file 1601, 7.b., for a verified end of a work period, populating and updating the presence record to reflect the end of the presence period and including data concerning the presence such as presence duration 1609 and speed 1601. The foregoing process steps result in a recordation, over time, of the following data for example: work presence times by the user at the employers' jobsite, the number and duration of absences from a work area during the work presence times, and a count of false positives which indicates a level of confidence in the reliability of the work presence record.

The foregoing description of Process 1 is most applicable to stationary job locations, i.e., when job location type field 1307 is “stationary.” In the case of a “transient” job location, i.e. a cross-country truck, Process 1 is modified as follows. In Step 4, an exit event from a “travel origin point” geofence type (stored in field 1208) is not considered a possible exit from the job site, and an entry event to a “travel destination point” geofence type is considered a possible exit of the job site. This reflects the fact that the travel time between the origin and destination is considered a work time for a “transient” job location.

As Process 1 is repeatedly executed over a period of time, a record of the employee's work time and attendance is built up in presence file 1601, subject to verification and correction in Process 2.

Process 2: Verification and Correction of Daily Time and Attendance Data.

Process 2 is executed by the subject technology on a periodic basis, for example, daily or weekly, to verify and clean up the data stored in presence file 1601. Process 2 includes the steps of: 1. Comparing the stored presence entries in presence file 1601 with the work schedule data structure 1308 (if present) to detect discrepancies between the recorded presence periods and the work schedule; 2. Conditional on discrepancies being detected in step 1, displaying a notification on device 200 for data entry by the user to confirm or modify the presence data; 3. Updating the presence data in file 1601 according to the data entered by the user in step 2.

Process 3: Identification of Potential Violations of Regulations.

Process 3 is executed by the subject technology on a periodic basis, for example, daily or weekly, to build and populate the violations file 1801. In Process 3, the system of the subject technology reads, analyses and processes the presence data file 1601 collected in Process 1 and verified in Process 2, the pay record file 1401, and the regulation file 1101, to detect potential violations of wage and hour laws and regulations by the employer in paying the user, and to populate and write records in violations file 1801 for later retrieval and processing. Process 3 may include the following steps, for a predetermined time period (e.g. a workweek beginning on a given day and ending on a given day): 1. Identify from regulation file 1101 the applicable regulations for the given employee, employer, and time period, 2. For each applicable regulation identified in step 1, read the presence file records 1601 for the predetermined time period and calculate the work time of the employee for the employer during the predetermined time period, as required for the applicable regulation time period type (for example, if the regulation is type “hour,” calculate number of hours worked, similarly for a “day” or “week” type, etc.), 3. Read the pay record file records 1401 and calculate the wage actually paid for each regulation time period type (for example, total wage paid divided by total presence hours for an “hour” type regulation, similarly for a “day” or “week” type), 4. Using the results of step 2 and step 3, calculate the rate actually paid (for example, divide wage actually paid by number of hours to determine hourly rate actually paid, in the case of an “hour” type regulation), 5. Compare the result of step 4 with the applicable regulated rate stored in regulated rate field 1110 for the applicable regulation, for the purpose of determining whether there is a discrepancy (e.g., hourly rate actually paid was less than the regulated rate of type “hour”), 6. Conditional on determining that there is a discrepancy, populate and write a violation record in violation file 1801. Step 6 may include calculating a value representing a level of confidence in the violation record and populating the value into confidence field 1809. For example, the value representing a level of confidence may have a range of 100 (best) to 0 (worst) and may be calculated as a function of one or more of the following aspects of presence records processed in step 2: the total number of false positives recorded in false positive counter 1612, the total number of absences recorded in absence count field 1614, the total time of absences recorded in absence time field 1613.

As Process 3 is repeatedly executed over a period of time, a record of possible violations of wage and hour laws and regulations by the employer is built up in violation file 1801, for further analysis and use as explained hereafter.

Process 4: Population of Employer Risk File from Violation Data.

Process 4 is executed by computer system 300 of the subject technology on a periodic basis, for example, daily or weekly, to build and populate a portion of the employer risk file 1701. It should be understood from the foregoing description that the employer risk file 1701 stores a variety of risk factors for an employer, including the number, frequency, magnitude, pervasiveness, and confidence of violations of regulations detected and stored in violation file 1801 by Process 3. In an embodiment, the following employer risk types are of this nature (i.e., potential violation risk factors): recidivist risk level (individual) (i.e., frequency of total violations per user based on defined period), recidivist risk level (workforce, i.e., number of users with violations from the same employer), monetary level (individual) (i.e. dollar amount owed per total violations per user), monetary level (workforce) (i.e., dollar amount owed per total violations per all users of same employer, cycle time (individual and workforce) (i.e, the number of days/hours between violations of each user to determine, among others, information staleness), duration (individual and workforce) (i.e., comparison of earliest and latest determined violations per user), corroboration (i.e., comparison of geofence breaches to other devices, activity monitors and across multiple users of same employer), false positive (i.e., measurement of potentially incorrect geofence recordings for real-time correction such as more time spent outside than inside the geofence on a given shift). Process 4 includes the following steps, for a given date range and a given employer risk type: 1. Read violation records from violation file 1801 having a violation period start field 1806 and a violation period end field 1807 in the given date range, 2. Determine the appropriate contents of employer risk data structure 1706, based on the violation records from step 1 and the given employer risk type, 3. Populate and write the employer risk record in employer risk file 1701. It will be understood that how step 2 is carried out will depend on the employer risk type, and may involve reading other data files of the subject technology. For example, if the given risk type is recidivist risk level (individual) (i.e., frequency of total violations per user based on defined period), step 2 will require the steps of 2.a, accumulating the total number of violations in the given date range, 2.b accumulating the total number of employees represented for this employer in employee file 1301, calculating the quotient of total number of violations divided by total number of employees, 2.c, populating the data structure 1706 with the quotient. A person of skill in the art will be able to determine the proper procedures of step 2 for other employer risk types.

Process 5: Population of Employer Risk File from Public Data.

The employer risk data that is derived from the detected probable violations, by Process 4, is only part of the overall risk profile of an employer. The subject technology brings together that granular observation-based data with more global parameters, to result in a more complete understanding of employer risk of compliance litigation. In part, the more global parameters are determined by an embodiment of the subject technology by digital access to public records, parsed, formatted, and written as employer risk records in employer risk file 1701. For example, the employer risk type “judgment proof (i.e., publicly available information on the company including asset and liability searches, outstanding judgments and liens, prior bankruptcy filings, history of prior lawsuits)” may be populated in employer risk file 1701 by accessing and parsing public files of judgment, liens, bankruptcy filing, and lawsuits, and assigning the employer a judgment proof value from, for example, 0 (judgment collection virtually impossible) to 100 (judgment collection highly probable), which is then stored in an employer risk data structure 1706 and written as employer risk record for this employer and risk type. As another example, the employer risk type of “class/collective action viability (i.e., comparison of the number of employees in the job classification from the user registration phase or publicly available information)” may be populated by accessing and parsing public files of employee data for the given employer, and assigning a value from, for example, 0 (class or collective action virtually impossible) to 100 (class or collective action highly probable), which is then stored in an employer risk data structure 1706 and written as employer risk record for this employer and risk type. To take another example, the employer risk type of “venue (i.e., compared with average figures from similar cases or averages for segments of prior cases in relation to gross settlement amounts, attorney hourly rates, and approved distribution awards)” may be populated by accessing and parsing public files of judgments and settlements for the employer's venue (i.e., state in which the employer operates) and populating an employer risk data structure 1706 with appropriate values (for example, average judgment amount, average settlement amount, prevailing attorney hourly rate in the venue, average distribution award), and writing an employer risk record in file 1701 with that information. A person of skill in the art will be able to determine the proper procedures of Process 5 for other employer risk types. And this is not to exclude the possibility of manual data entry of employer risk data, to further supplement the automatically collected and parsed employer risk data.

As Processes 4 and 5 are repeatedly executed over a period of time, a record of employer risk factors is built up in employer risk file 1801, for further analysis and use as explained hereafter.

Process 6: Analysis of Employer Risk Data.

In Process 6, the employer risk file 1801 that was built up in Processes 1-5 is analyzed and exploited by a digital risk analysis engine to inform judgment calls concerning an individual employer. The employer risk file 1801 is very valuable for this purpose and the data may be exploited in a variety of different ways. For example, a scoring algorithm may be employed to assign values to various aspects of the employer risks stored in file 1801, to result in an overall score from, for example, 0 (enforcement action very unlikely) to 100 (enforcement action highly unlikely). Process 6 may also employ data mining techniques and/or artificial intelligence to exploit the employer risk data and result in the overall risk score.

The ultimate uses of the output of Process 6 are manifold, and the exact algorithms and other processing steps will necessary depend upon the ultimate use. For example, if the subject technology is being used by a plaintiff's firm to identify possible defendant employers for enforcement action, the “judgment proof” and “monetary level (workforce)” aspects of the employer risk may be very important and weigh heavily in determining the score (because it is not desirable to sue an employer that cannot pay a judgment, or if the expected judgment would be small). However, if the subject technology is being used by a Wage and Hour Division of a state attorney general office, these aspects may be unimportant. If the subject technology is being used by a potential merger partner, these aspects may be of middling importance. A person of skill in the art would be able to weight the various employer risk aspects to carry out Process 6 given the needs of the end user of the subject technology.

While specific embodiments of the invention have been shown and described in detail to illustrate the application of the principles of the invention, it will be understood that the invention may be embodied otherwise without departing from such principles. It will also be understood that the present invention includes any combination of the features and elements disclosed herein and any combination of equivalent features. The exemplary embodiments shown herein are presented for the purposes of illustration only and are not meant to limit the scope of the invention.

What is claimed is:

1. A method for determining a level of risk of wage-and-hour litigation against a company, the method comprising the steps of:
receiving, and storing in digital data storage, time-and-attendance data for employees of the company, during a time period, the time-and-attendance data received from a plurality of mobile devices having geolocation capability and carried by employees of the company during work times, the time-and-attendance data generated at least in part by detection by the mobile devices of breaches of a geofence, the breaches representing entry into and exit from the geofence, the geofence associated with a workplace of the company, the time-and-attendance data including employee presence duration, employee absence data, and a count of false-positive breaches of the geofence;
receiving, and storing in digital data storage, payment records of compensation paid by the company to the employees for work performed during the time period;
determining using a compliance engine, and storing in digital data storage, confidence-weighted potential violations of wage-and-hour regulations by the employer, the compliance engine identifying the potential violations by analysis of the time-and-attendance data, the payment records, and a digital library of wage-and-hour regulations, the analysis including identifying applicable wage-and-hour regulations according to a type of employee, a type of employer, and a jurisdiction, and confidence-weighting the potential violations based on at least one of the employee absence data and the count of false-positive breaches of the geofence;
determining, and storing in digital data storage, potential violation risk factors, based on the confidence-weighted potential violations, the potential violation risk factors including at least one of the following: recidivist risk level, monetary level, cycle time, duration, corroboration, false positive;
receiving, and storing in digital data storage, additional risk factors associated with the employer, the additional risk factors including at least one of the following: a judgment proof value, class action viability, collective action viability, venue, projected legal costs, dismissal rate;
determining, using a digital risk analysis engine, the level of risk of wage-and-hour litigation against the company based on the confidence-weighted potential violations and the additional risk factors.

2. A system for determining a level of risk of wage-and-hour litigation against a company, the system comprising:
a computer system, the computer system comprising digital data storage and one or more processors;
the computer system programmed and configured to receive, and store in the digital data storage, time-and-attendance data for employees of the company, during a time period, the time-and-attendance data received from a plurality of mobile devices having geolocation capability and carried by employees of the company during work times, the time-and-attendance data generated at least in part by detection by the mobile devices of breaches of a geofence, the breaches representing entry into and exit from the geofence, the geofence associated with a workplace of the company, the time-and-attendance data including employee presence duration, employee absence data, and a count of false-positive breaches of the geofence;
the computer system programmed and configured to receive, and store in the digital data storage, payment records of compensation paid by the company to the employees for work performed during the time period;
the computer system comprising a compliance engine, configured to determine, and store in the digital data storage, confidence-weighted potential violations of wage-and-hour regulations by the employer, the compliance engine identifying the potential violations by analysis of the time-and-attendance data, the payment records, and a digital library of wage-and-hour regulations, the analysis including identifying applicable wage-and-hour regulations according to a type of employee, a type of employer, and a jurisdiction, and confidence-weighting the potential violations based on at least one of the employee absence data and the count of false-positive breaches of the geofence;
the computer system configured to determine, and storing in digital data storage, potential violation risk factors, based on the confidence-weighted potential violations, the potential violation risk factors including at least one of the following: recidivist risk level, monetary level, cycle time, duration, corroboration, and false positive;
the computer system configured to receive, and store in the digital data storage, additional risk factors associated with the employer, the additional risk factors including at least one of the following: a judgment proof value, class action viability, collective action viability, venue, projected legal costs, and dismissal rate;
the computer system comprising a digital risk analysis engine configured to determine the level of risk of wage-and-hour litigation against the company based on the confidence-weighted potential violations and the additional risk factors.

3. A method for detecting potential violations of wage-and-hour laws using automatically collected time-and-attendance of an employee of a company, the method comprising the steps of:
collecting, receiving, and storing in digital data storage, time-and-attendance data for the employee of the company, during a time period, the time-and-attendance data received from a mobile device carried by the employee during work times and having geolocation capability, the time-and-attendance data generated at least in part by detection by the mobile device of breaches of a plurality of geofences, the breaches representing entry into and exit from at least of the plurality of geofences, the plurality of geofences being associated with the company, the time-and-attendance data including employee presence duration, and employee absence data;
detecting a potential error in the time-and-attendance data during collecting of the time-and-attendance data; and
displaying a prompt on the mobile device to prompt the employee to verify the time-and-attendance data in response to detection of the potential error.
